(19) United States
(12) Patent Application Publication
(10) Pub. No.: US 2016/0147753 A1
(43) Pub. Date: May 26, 2016

(54) Suggesting Content for Discovery Based on User Interests and Authorship

(71) Applicant: Facebook, Inc., Menlo Park, CA (US)

(72) Inventors: Thomas Frederick Dimson, Stanford, CA (US); Michel Krieger, San Francisco, CA (US)

(21) Appl. No.: 14/548,965

(22) Filed: Nov. 20, 2014

(51) Int. Cl. G06F 17/30; H04L 29/06

(52) U.S. Cl. CPC G06F 17/3053; H04L 65/403

(57) ABSTRACT

An online system allows its users to posts content to the system and to see the content posted by other users of the system. The system helps users discover new content and sources thereof that may be interesting. For example, a first user expresses an interest in a content item and communicates that interest to the system. The system then identifies a second user who posted that liked content item and identifies content items in which the second user has communicated an interest. Based on this, the system selects one or more of the content items liked by the second user and provides the selected content items to the first user. The system may decline to send the content item to the first user if it was posted by a third user with whom the first user has already established a connection.

### BACKGROUND

This invention relates generally to social networking, and more specifically to suggesting content to a user to allow the user to explore and discover new content.

Social networking systems have become ubiquitous, and the amount of data in social networking systems is expanding exponentially. Social networking systems allow users to connect and interact with each other. For example, users may become engaged with each other by sharing photos or articles, updating real-time statuses, organizing events, or playing games. The growth of the Internet and of mobile technologies has transformed social networks into a prime source for information to many users. As a result, many users are overwhelmed by the exploding amount of information. Providing information that is more tailored to a user based on the user's interests is therefore needed.

### SUMMARY

An online system, such as a social networking system, allows its users to posts content to the system and to see the content posted by other users of the system. Since the volume of content in the system may be large, the system suggests content that may be of interest to a user to help the user discover new content and sources thereof that may be interesting to the user. For example, if a user likes content published by another user, their interest in content may be similar. Accordingly, a user's interests in content may be used as a potential source of content suggestions to other users who have expressed an interest in content actually posted by that user.

In one embodiment, a first user expresses an interest in a content item and communicates that interest to the system. For example, the first user may select a “like” option in connection with a picture displayed in a feed of content items on a social networking system. The system then identifies a second user who posted that liked content item and identifies content items in which the second user has communicated an interest. These content items that the second user likes may also be liked by the first user, given that the first user liked a content item that the second user posted. Accordingly, the system selects one or more of the content items liked by the second user and provides the selected content items to the first user.

In one embodiment, the system determines whether a connection exists between the first user and a third user who posted one of the selected content items to the system. If there is an existing connection, then the system declines to send the content item that was posted by the third user as a suggestion to the first user. For example, if the connection is that the first user is already following content of the third user, then there would be marginal benefit for new content discovery in providing the third user's content to the first user. Moreover, if the connection is that the first user has blocked content from the third user, then providing the third user's content to the first user as a suggestion would contravene the first user's explicit request.

In one embodiment, to select the content items to be provided to the first user, a set of candidate content items (e.g., content items that were liked by the second user) are ranked based on a score that indicates a likelihood that the content item will be liked the first user if presented thereto. The selected content items are selected at least in part based on this ranking. The selected content items may be sent to the user in a content item feed.

### BRIEF DESCRIPTION OF THE DRAWINGS

FIG. 1 is a block diagram of a system environment in which a social networking system operates, in accordance with an embodiment of the invention.

FIG. 2 is a block diagram of a social networking system, in accordance with an embodiment of the invention.

FIG. 3 is a block diagram of a content suggestion module, in accordance with an embodiment.

FIG. 4A is a diagram showing content that may be suggested to a user, in accordance with an embodiment.

FIG. 4B is a diagram showing content that may be prevented from being suggested to a user, in accordance with an embodiment.

FIG. 5 is a flow chart of a method for suggesting content items to a user, in accordance with an embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### System Architecture

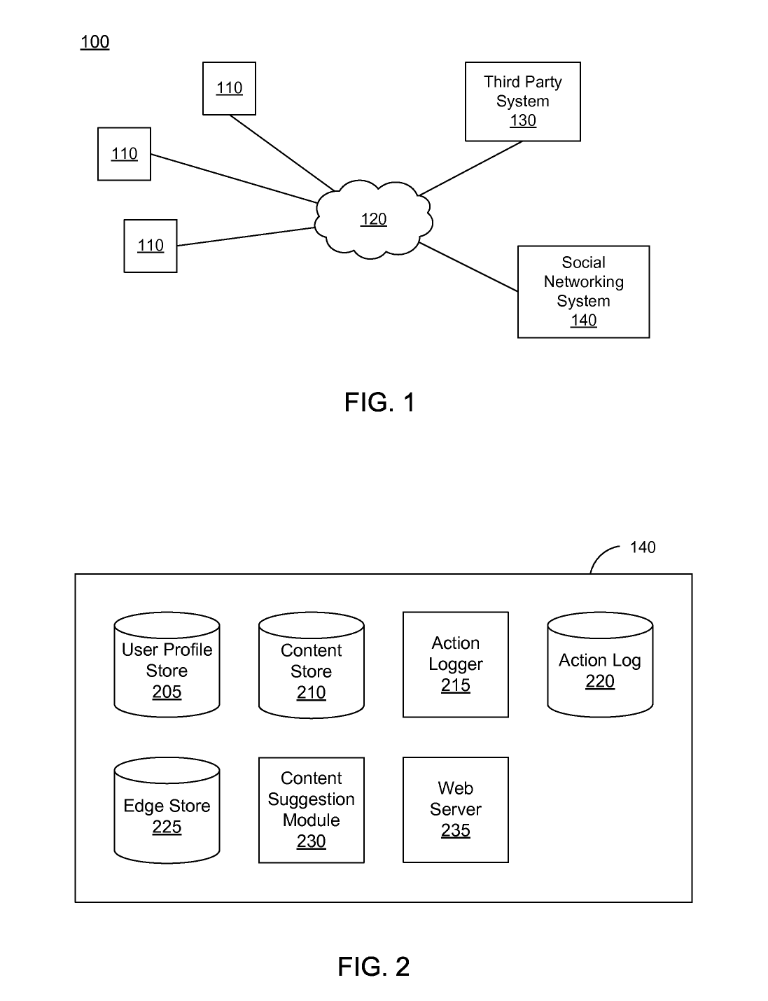

FIG. 1 is a high level block diagram of a system environment 100 for a social networking system 140. The system environment 100 shown by FIG. 1 comprises one or more client devices 110, a network 120, one or more third-party systems 130, and the social networking system 140. In alternative configurations, different and/or additional components may be included in the system environment 100. The embodiments described herein can be adapted to online systems that are not social networking systems.

The client devices 110 are one or more computing devices capable of receiving user input as well as transmitting and/or receiving data via the network 120. In one embodiment, a client device 110 is a conventional computer system, such as a desktop or laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the social networking system 140. For example, a client device 110 executes a browser application to enable interaction between the client device 110 and the social networking system 140 via the network 120. In another embodiment, a client device 110 interacts with the social networking system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the social networking system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party website 130 may also communicate information to the social networking system 140, such as advertisements, content, or information about an application provided by the third party website 130.

FIG. 2 is an example block diagram of an architecture of the social networking system 140. The social networking system 140 shown in FIG. 2 includes a user profile store 205, a content store 210, an action logger 215, an action log 220, an edge store 225, a content suggestion module 230, and a web server 235. In other embodiments, the social networking system 140 may include additional, fewer, or different components for various applications. Conventional components such as network interfaces, security functions, load balancers, failover servers, management and network operations consoles, and the like are not shown so as to not obscure the details of the system architecture.

Each user of the social networking system 140 is associated with a user profile, which is stored in the user profile store 205. A user profile includes declarative information about the user that was explicitly shared by the user and may also include profile information inferred by the social networking system 140. In one embodiment, a user profile includes multiple data fields, each describing one or more attributes of the corresponding user of the social networking system 140. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with identification information of users of the social networking system 140 displayed in an image. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the social networking system 140, user profiles may also be stored for entities such as businesses or organizations. This allows an entity to establish a presence on the social networking system 140 for connecting and exchanging content with other social networking system users. The entity may post information about itself, about its products or provide other information to users of the social networking system using a brand page associated with the entity's user profile. Other users of the social networking system may connect to the brand page to receive information posted to the brand page or to receive information from the brand page. A user profile associated with the brand page may include information about the entity itself, providing users with background or informational data about the entity.

The content store 210 stores objects that each represents various types of content. Examples of content represented by an object include a page post, a status update, a photograph, a video, a link, a shared content item, a gaming application achievement, a check-in event at a local business, a brand page, or any other type of content. Social networking system users may create objects stored by the content store 210, such as status updates, photos tagged by users to be associated with other objects in the social networking system, events, groups or applications. In some embodiments, objects are received from third-party applications or third-party applications separate from the social networking system 140. In one embodiment, objects in the content store 210 represent single pieces of content, or content “items.” Hence, users of the social networking system 140 are encouraged to communicate with each other by posting text and content items of various types of media through various communication channels. This increases the amount of interaction of users with each other and increases the frequency with which users interact within the social networking system 140.

The action logger 215 receives communications about user actions internal to and/or external to the social networking system 140, populating the action log 220 with information about user actions. Examples of actions include adding a connection to another user, sending a message to another user, uploading an image, reading a message from another user, viewing content associated with another user, attending an event posted by another user, among others. In addition, a number of actions may involve an object and one or more particular users, so these actions are associated with those users as well and stored in the action log 220.

The action log 220 may be used by the social networking system 140 to track user actions on the social networking system 140, as well as actions on third party systems 130 that communicate information to the social networking system 140. Users may interact with various objects on the social networking system 140, and information describing these interactions is stored in the action log 220. Examples of interactions with objects include: commenting on posts, sharing links, and checking-in to physical locations via a mobile device, accessing content items, and any other interactions. Additional examples of interactions with objects on the social networking system 140 that are included in the action log 220 include: commenting on a photo album, communicating with a user, establishing a connection with an object, joining an event to a calendar, joining a group, creating an event, authorizing an application, using an application, expressing a preference for an object (“liking” the object) and engaging in a transaction. Additionally, the action log 220 may record a user's interactions with advertisements on the social networking system 140 as well as with other applications operating on the social networking system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the social networking system 140. For example, an e-commerce website that primarily sells sporting equipment at bargain prices may recognize a user of a social networking system 140 through a social plug-in enabling the e-commerce website to identify the user of the social networking system 140. Because users of the social networking system 140 are uniquely identifiable, e-commerce websites, such as this sporting equipment retailer, may communicate information about a user's actions outside of the social networking system 140 to the social networking system 140 for association with the user. Hence, the action log 220 may record information about actions users perform on a third party system 130, including webpage viewing histories, advertisements that were engaged, purchases made, and other patterns from shopping and buying.

In one embodiment, an edge store 225 stores information describing connections between users and other objects on the social networking system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the social networking system 140, such as expressing interest in a page on the social networking system, sharing a link with other users of the social networking system, and commenting on posts made by other users of the social networking system.

In one embodiment, an edge may include various features each representing characteristics of interactions between users, interactions between users and object, or interactions between objects. For example, features included in an edge describe rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the social networking system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the social networking system 140 over time to approximate a user's affinity for an object, interest, and other users in the social networking system 140 based on the actions performed by the user. A user's affinity may be computed by the social networking system 140 over time to approximate a user's affinity for an object, interest, and other users in the social networking system 140 based on the actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

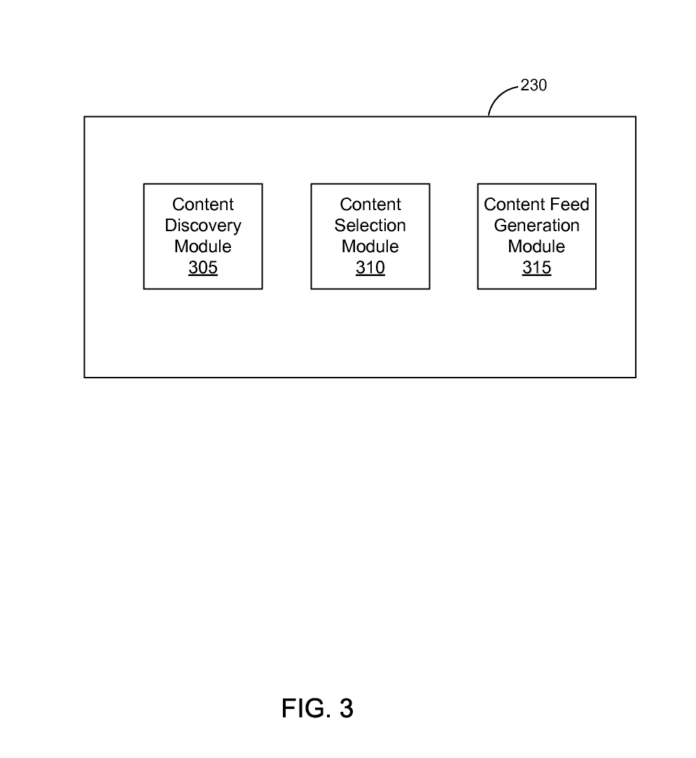

The content suggestion module is described with reference to FIG. 3, which is a block diagram of one embodiment of the content suggestion module 230. In the example shown by FIG. 3, the content suggestion module 230 includes a content discovery module 305, a content selection module 310, and a content feed generation module 315. The content discovery module 305 may discover or determine a list of candidate content items to suggest to a user. The content selection module 310 may select, from the list of candidate content items, one or more content items for suggestion to the user. The discovery and determination of content items may be based on the information stored in the user profile store 205, the content store 210, the action log 220, and the edge store 225.

A content item may be a page post, a picture, a video, or an object made available for viewing by the owner on one or more social networking systems (e.g., the social networking system 140.) The owner may choose to share a content item by publishing it to the public or to the private for viewing. A content item shared to the public may be viewable by everyone whereas a content item shared to the private may be viewable only by one or more users selected by the owner. For example, a private content item is made available only to the user following the owner of the content item for viewing. The owner of the content item is a user that publishes the content item. A user viewing a content item may indicate his or her interest in the content item by taking an action such as re-sharing, commenting on, or liking the content item. Liking the content item may be performed by interacting with (e.g., clicking on, tapping on, double-clicking) a control element (e.g., a button, the content item) that triggers a predetermined condition. A user's interest in a content item may be detected and recorded when the user takes an action. The user's interest in a content item may be associated with the user and stored in one or more data stores (e.g., the user profile store 205, the content store 210, the action log 220, or the edge store 225.)

A content item, when published, may be sent to a user in a content feed. A user may choose to view different content items by selecting different content feeds. The connection between a user and the owner of a content item may determine the content feed in which the content item is sent to the user. Content items published by users to whom a user is connected similarly are sent to the user in one feed, and a content item is sent to a user in only one content feed. A user may follow one or more users and such following may need approval from the users being followed. Content items published by users that a user follows may be sent to the user in a content item feed. Content items, published by users that a user does not follow but to the public and popular, may be sent to the user in one content item feed. A content item may be popular when it receives attention from users, such as receiving the most indications of interest from users.

In one embodiment, the social networking system 140 identifies content items likely to be of interest to a user through a content item feed presented to the user. A content item sent to a user receives interest from an additional user that publishes a content item of interest to the user. The content suggestion module 230 may generate content items for presentation to a user based on information in the action log 220 and in edge store 225 or may select candidate content items included in content store 210. One or more candidate stories are determined, processed, and sent to a user by the content suggestion module 230.

For example, the content suggestion module 230 receives an indication of interest from a user with respect to a content item. The content suggestion module 230 accesses one or more of the user profile store 105, the content store 110, the action log 120, and the edge store 225 to retrieve information about the identified user and the content item. For example, the owner of the content item and data associated with the owner of the content item or users connected to the identified user are retrieved. The retrieved data is analyzed by the content suggestion module 230 to identify content items likely to be of interest to the identified user. For example, content items liked by the owner of the content item but published by users to whom the identified user is connected are discarded as candidate content items. Based on various criteria, the content suggestion module 230 processes and selects one or more content items for suggestion to the identified user from the candidate content items.

In various embodiments, the content suggestion module 230 sends the selected content items to a user through a content item feed. The selected content items may be presented to the user via the content item feed. The content item feed may include a limited number of content items or may include the complete set of content items. The number of content items included in a content item feed may be determined in part by a user preference included in user profile store 205. The content suggestion module 230 may also determine the order in which the content items are presented. For example, the content suggestion module 230 determines that a user has a highest affinity for a specific user and increases the number of content items in the content items feed associated with the specific user or modifies the positions in the content item feed where content items associated with the specific user are presented.

The content suggestion module 230 may also account for actions by a user indicating a preference for types of content items and selects content items having the same, or similar, types for inclusion in the content item feed. Additionally, content suggestion module 230 may analyze content items received by social networking system 140 from various users and obtains information about user preferences or actions from the analyzed content items. This information may be used to refine subsequent selection of content items for content item feed presented to various users.

The web server 235 links the social networking system 140 via the network 120 to the one or more client devices 110, as well as to the one or more third party systems 130. The web server 140 serves web pages, as well as other web-related content, such as JAVA®, FLASH®, XML and so forth. The web server 235 may receive and route messages between the social networking system 140 and the client device 110, for example, instant messages, queued messages (e.g., email), text messages, short message service (SMS) messages, or messages sent using any other suitable messaging technique. A user may send a request to the web server 235 to upload information (e.g., images or videos) that are stored in the content store 210. Additionally, the web server 235 may provide application programming interface (API) functionality to send data directly to native client device operating systems, such as IOS®, ANDROID™, WEBOS® or BlackberryOS.

FIG. 3 is a block diagram of a content suggestion module, in accordance with an embodiment. As illustrated, the content suggestion module 230 comprises a content discovery module 305 and a content selection module 310. The content discovery module 305 is configured to determine a list of candidate items in which a user may be interested. The list of candidate items may be further processed before being suggested to a user. The list of candidate items may be determined based on one or more content items that a user has indicated his or her interest. A user is likely to like a content item liked by someone publishing a content item that the user already likes. In various embodiments, the content discovery module 305 determines one or more content items receiving indication of interest by the owner of a content item that a user has indicated interest. A list of candidate content items may include all content items that receive indication of interest from all the users who publish content items that a user indicates interest. In various embodiments, such determination is performed dynamically.

The content selection module 310 is configured to select one or more content items for suggestion to a user from a list of candidate content items determined by the content discovery module 305. The selected content items may be subsequently sent to a user. The content selection module 310 may be configured to remove content items, from a list of candidate items, if the content items were published by another user that the user follows. That is, a content items published by another user already being followed by a user may be determined not to be suggested to the user. In addition, a content item published by another user being blocked by a user may be determined not to be suggested to the user.

The content selection module 310 may be configured to rank a list of candidate items for suggestion to a user. The list of candidate content items may be ranked according to the likelihood of receiving an indication of interest from a user. A candidate content item more likely to receive an indication of interest may be ranked higher than another candidate content item less likely to receive an indication of interest from the user. For example, to a basketball player, a content item related to a basketball game may be ranked higher than a content item related to a baseball game. In some embodiments, the content selection module 310 may be configured to determine a score indicating the likelihood of a content item being of interest to a user. A score may be determined for every candidate content item and all candidate content items may be ranked according to the score. A threshold score may be determined for a user. The threshold score corresponds to a candidate content item of which the likelihood of a user indicating an interest equals to the unlikelihood of the user indicating an interest. Candidate content items with scores exceeding the threshold score may be selected for suggestion to the user. In some embodiments, the content selection module 310 may be configured to rank content items randomly.

The content feed generation module 315 is configured to generate a content feed for suggesting the content items selected by the content selection module 310 to a user. The content item feed generated by the content item feed generation module 315 may be separate from other content item feeds. In one embodiment, only content items selected by the content feed selection module 310 are sent to a user in the content feed generated by the content feed generation module 315. In one embodiment, all candidate items determined by the content discovery module 305 are sent to a user. The content feed generation module 315 may be configured to determine an order in which the content items are sent to a user. In one embodiment, an order of sending content items is determined according to a score indicating the likelihood of a content item receiving an indication of interest from a user. The content feed generation module 315 is configured to generate a content item feed dynamically. For example, at a time point, a new content item liked by the owner of a content item liked by a user may be determined as a candidate content item for suggestion to a user and instantaneously added to the list of candidate content items determined by the content discovery module 305.

This new content item may be further selected as a content item for suggestion to the user by the content selection module 310 recursively. The content item feed generated by the content feed generation module 315 may send this new content item to the user dynamically. As such, a user may traverse the content item feed more effectively. For example, Jane likes a pug picture published by John, John likes a French bulldog picture published by Kate, and Jane does not follow John or Kate. The French bulldog picture is selected and suggested to Jane in a content item feed. Later, John likes an English bulldog picture published by Dan and Jane does not follow Dan. The English bulldog picture is selected and suggested to Jane along with the French bulldog picture in the content item feed. Selecting and sending the English bulldog picture to Jane in the content item feed is performed dynamically and recursively.

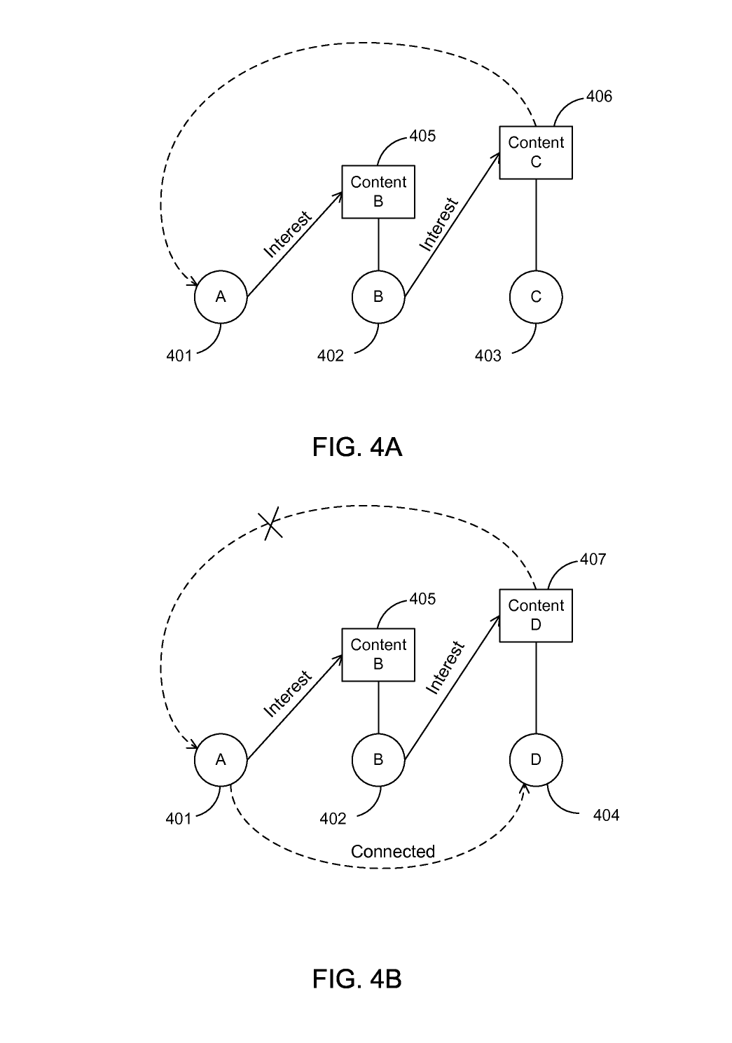

FIG. 4A is a diagram showing content that may be suggested to a user, in accordance with an embodiment. In the illustrated example, a user 401 expresses interest in a content item 405 published by a user 402. The user 402 also expresses interest in a content item 406 published by a user 403. The user 401 and the user 402 may express interest by taking an action that is recognized as indication of interest such as commenting on, interacting with a user interface component that explicitly indicates an interest (e.g., a “like”), or sharing a content item. In this example, the user 401 is not connected to the user 402 or the user 403. For example, the user 401 does not follow the user 402 or the user 403, nor does the user 401 block the user 403. The user 401 may be connected to the user 402. The content item 406 published by the user 403 is thus determined as a candidate content item for suggestion to the user 401. The content item 406 may be processed along with other candidate items. Once selected, the content item 406 is sent to the user 401 in a content item feed.

FIG. 4B is a diagram showing content that may be prevented from being suggested to a user, in accordance with an embodiment. In the illustrated example, a user 401 expresses interest in a content item 405 published by a user 402. The user 402 expresses interest in the content item 407 published by a user 404. The user 401 and the user 402 may express interest by taking an action that is recognized as indication of interest such as commenting on, interacting with a user interface component, or sharing a content item. The user 401 is not connected to the user 402, but the user 401 is connected to the user 404. For example, the user 401 follows the user 404, or the user 401 blocks the user 404 such that content items published the user 404 are not made viewable to the user 401. The content item 407 published by the user 404 is excluded from the list of candidate content items for suggestion to the user 401 because the user 401 is connected to the user 404.

### Content Suggestion Method

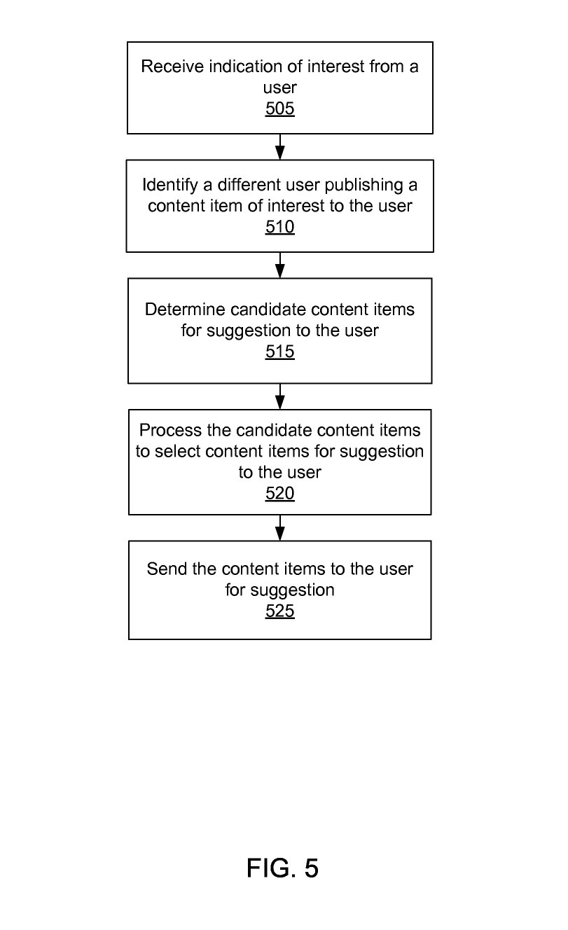

FIG. 5 is a flow chart of one embodiment of method for suggesting content items to a user, in accordance with an embodiment. In various embodiments, the steps described in conjunction with FIG. 6 may be performed in different orders. Additionally, different and/or additional steps than those described in conjunction with FIG. 6 may be performed in some embodiments.

At block 505, an indication of interest in a content item is received from a user. For example, a user may tap twice on a picture to indicate that he or she likes the picture. The user's indication of interest in a content item may be received by a server (e.g., the social networking system 140). In some embodiments, the user's indication of interest in a content item is associated with the user and stored. At block 510, a user that publishes the content item receiving the indication of interest from the user is identified. That is, the owner of the content item that the user indicates his or her interest is identified.

At block 515, candidate content items for suggestion to the user are determined. In various embodiments, the content items receiving indication of interest from the user identified at block 510 are determined as candidate content items for suggestion to the user. A candidate content item may likely receive an indication of interest from the user. A candidate content item may be retrieved from a content store 210. At block 520, the candidate content items determined at block 515 are processed. One or more content items may be selected from the candidate content items. In some embodiments, the owner of each candidate content item is identified. Whether the owner of a candidate content item is connected to the user may be evaluated. A candidate content item may be removed from the list of candidate content items when the owner of the candidate content item is connected to the user such that the connection meets a predetermined condition. For example, a user may already follow the owner of a candidate item, in which case, content items published by the owner are made viewable to the user. A user may block the owner of a candidate item, in which case, the user nearly has no interest in any content published by a person he or she blocks.

In some embodiments, candidate content items may be ranked. Ranking of candidate content items may be random such that the candidate content items from different sources are aggregated and shuffled. Candidate content items may be ranked according to a criterion (e.g., a likelihood of being of interest to a user, an object, the number of existing indications of interest received such as comments or likes, the number of followers that the owner of the content item has, popularity among users, or the publication time). In one embodiment, a score indicating the likelihood of a content item being of interest to a user may be determined for each candidate content item. The score may be determined similarly to the affinity scores, or “affinities,” as described herein. Candidate content items may be ranked according to the score. One or more top candidate items and/or candidate items having scores exceeding a threshold may be selected and suggested to the user.

At block 525, the content items selected at block 520 are sent to the user for suggestion. The content items may be sent to the user in an order according to how they were ranked. A content item feed may be created for sending and suggesting the content items to the user.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
receiving, from a first user at an online system, a first indication of interest in a first content item;
identifying a second user who posted the first content item to the online system;
determining a first set of content items, where the online system received an indication of interest in each of the first set of content items from the second user;
selecting one or more of the first set of content items; and
sending of the selected content items for display to the first user.

2. The method of claim 1, further comprising:
ranking the first set of content items,
wherein the selecting one or more of the first set of content items is based on the ranking of the content items.

3. The method of claim 2, wherein ranking the first set of content items comprises:
determining a score for each content item of the first set of content items, the score indicating a likelihood of the content item receiving an indication of interest from the first user; and
organizing the first set of content items based on the score for the each content item.

4. The method of claim 2, wherein the selected content items are sent for display to the first user in an order based at least in part on the ranking.

5. The method of claim 1, further comprising:
determining a score for each content item of the first set of content items, the score indicating a likelihood of the content item receiving an indication of interest from the first user,
wherein the selecting one or more of the first set of content items is based on whether the score for each content item exceeds a threshold score.

6. The method of claim 1, further comprising:
determining that a third user posted one or more of the content items of the first set of content items to the online system;
determining that the first user has connected to the third user in the online system; and
based on the connection from the first user to the third user, excluding from the selected content items the one or more of the content items posted by the third user.

7. The method of claim 6, wherein the connection comprises the first user following the third user such that the online system provides content posted by the third user to the first user based on the connection.

8. The method of claim 6, wherein the connection comprises the first user blocking the third user such that the online system filters content posted by the third user from being provided to the first user based on the connection.

9. The method of claim 1, further comprising:
receiving, from the second user, a second indication of interest in a second content item,
wherein the first set of content items of interest comprises the second content item.

10. The method of claim 1, wherein sending of the selected content items for display to the first user comprises:
creating a content item discovery feed that comprises the selected content items and one or more additional content items; and
sending the content item discovery feed for display to the first user.

11. A computer program product comprising a non-transitory computer-readable storage medium containing computer program code for:
receiving, from a first user at an online system, a first indication of interest in a first content item;
identifying a second user who posted the first content item to the online system;
determining a first set of content items, where the online system received an indication of interest in each of the first set of content items from the second user;
selecting one or more of the first set of content items; and
sending of the selected content items for display to the first user.

12. The computer program product of claim 11, where the computer-readable storage medium further contains computer program code for:
ranking the first set of content items,
wherein the selecting one or more of the first set of content items is based on the ranking of the content items.

13. The computer program product of claim 12, wherein ranking the first set of content items comprises:
determining a score for each content item of the first set of content items, the score indicating a likelihood of the content item receiving an indication of interest from the first user; and
organizing the first set of content items based on the score for the each content item.

14. The computer program product of claim 12, wherein the selected content items are sent for display to the first user in an order based at least in part on the ranking.

15. The computer program product of claim 11, where the computer-readable storage medium further contains computer program code for:
determining a score for each content item of the first set of content items, the score indicating a likelihood of the content item receiving an indication of interest from the first user,
wherein the selecting one or more of the first set of content items is based on whether the score for each content item exceeds a threshold score.

16. The computer program product of claim 11, where the computer-readable storage medium further contains computer program code for:
determining that a third user posted one or more of the content items of the first set of content items to the online system;
determining that the first user has connected to the third user in the online system; and
based on the connection from the first user to the third user, excluding from the selected content items the one or more of the content items posted by the third user.

17. The computer program product of claim 16, wherein the connection comprises the first user following the third user such that the online system provides content posted by the third user to the first user based on the connection.

18. The computer program product of claim 16, wherein the connection comprises the first user blocking the third user such that the online system filters content posted by the third user from being provided to the first user based on the connection.

19. The computer program product of claim 11, where the computer-readable storage medium further contains computer program code for:
receiving, from the second user, a second indication of interest in a second content item,
wherein the first set of content items of interest comprises the second content item.

20. The computer program product of claim 11, wherein sending of the selected content items for display to the first user comprises:
creating a content item discovery feed that comprises the selected content items and one or more additional content items; and
sending the content item discovery feed for display to the first user.
